(19) United States
(12) Patent Application Publication
(10) Pub. No.: US 2024/0357533 A1
(43) Pub. Date: Oct. 24, 2024

(54) APPARATUS, METHODS, AND COMPUTER PROGRAMS FOR PROPAGATION DELAY DETERMINATION

(71) Applicant: Nokia Technologies Oy, Espoo (FI)

(72) Inventors: Thomas Haaning JACOBSEN, Aalborg (DK); Jan Torst HVIID, Aalborg (DK); Troels Emil KOLDING, Aalborg (DK)

(21) Appl. No.: 18/688,215

(22) PCT Filed: Sep. 27, 2021
(86) PCT No.: PCT/EP2021/076479

§ 371 Date: Feb. 29, 2024

(51) Int. Cl. H04W 56/00; H04L 47/283

(52) U.S. Cl. CPC H04W 56/0065; H04L 47/283

(57) ABSTRACT

There is provided a method, computer program and apparatus for causing an access point to: signal, to a user equipment, first and second configurations for determining respective propagation delays; receive, from the user equipment, an indication of at least one measurement associated with the first and second configurations; determine at least one of an accuracy and a reliability of the second propagation delay mechanism using the received at least one indication of at least one measurement; determine whether to modify the first and/or second configuration in dependence on the determined accuracy and/or reliability; and when it is determined to modify the first and/or second configuration, signal the modified first and/or second configuration to the user equipment.

### FIELD

The present disclosure relates to apparatus, methods, and computer programs, and in particular but not exclusively to apparatus, methods and computer programs for network apparatuses.

### BACKGROUND

A communication system can be seen as a facility that enables communication sessions between two or more entities such as user terminals, access nodes and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Content may be multicast or uni-cast to communication devices.

A user can access the communication system by means of an appropriate communication device or terminal. A communication device of a user is often referred to as user equipment (UE) or user device. The communication device may access a carrier provided by an access node and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known is the long-term evolution (LTE) or the Universal Mobile Telecommunications System (UMTS) radio-access technology. Another example communication system is so called 5G system that allows user equipment (UE) or user device to contact a 5G core via e.g. new radio (NR) access technology or via other access technology such as Untrusted access to 5GC or wireline access technology.

### SUMMARY

According to a first aspect, there is provided an apparatus for an access point, the apparatus comprising means for: signalling, to a user equipment, a first configuration for the user equipment to perform at least one measurement for determining a propagation delay for signalling between the user equipment and the access point at a first time and a third time using a first propagation delay mechanism; signalling, to the user equipment, a second configuration indicating at least one measurement event for determining a propagation delay for signalling between the user equipment and the access point at a second time using a second propagation delay mechanism, wherein the second time is configured relative to the first time and occurs between the first and third times; receiving, from the user equipment, an indication of at least one measurement associated with the first and second configurations; determining at least one of an accuracy and a reliability of the second propagation delay mechanism using the received at least one indication of at least one measurement; determining whether to modify the first and/or second configuration in dependence on the determined accuracy and/or reliability; and when it is determined to modify the first and/or second configuration, signalling the modified first and/or second configuration to the user equipment.

The apparatus may comprise means for determining a first value for a propagation delay for signalling using the first propagation delay mechanism at the first time and at least one measurement associated with the first configuration received from the user equipment.

The means for receiving may comprise means for receiving a first value for a propagation delay associated with the first configuration at the first time.

The second configuration may indicate a plurality of times between the first time and the third time for said measurement events.

The apparatus may comprise means for determining a second value for a propagation delay using the first propagation delay mechanisms at the third time and at least one measurement associated with the first configuration received from the user equipment.

The means for receiving may comprise means for receiving a second value for a propagation delay associated with the first configuration at the third time.

The means for determining an accuracy of the second propagation delay may comprise means for: determining a first difference between the first value and the second value; determining a first sum of propagation delay values associated with the second configuration at the plurality of times; and determining an accuracy of the second propagation delay mechanism by comparing a difference between the first difference and said sum to a first threshold.

The means for determining an accuracy of the second propagation delay may comprise means for: determining a second sum of propagation delay values associated with the second configuration at the plurality of times using measurements performed by the access point; receiving a third sum of propagation delay values associated with the second configuration at the plurality of times from the user equipment; and determining a reliability of the second delay mechanism by comparing a difference between the second sum and the third sum to a second threshold.

The indication of at least one measurement may comprise a difference between a first difference between the first value and the second value and a first sum of propagation delay values associated with the second configuration at the plurality of times.

The modified second configuration may indicate that measurements according to the second configuration should cease.

The modified first configuration may indicate that a time between making measurements associated with the first propagation delay mechanism should increase.

The first propagation delay mechanism may be a round trip time mechanism and the second propagation delay mechanism may be a timing advance mechanism.

The first propagation delay mechanism may provide a more accurate value for a propagation delay between the access point and the user equipment than the second propagation delay mechanism.

The first propagation delay mechanism may comprise more signalling overhead for calculating a propagation delay between the access point and the user equipment than the second propagation delay mechanism.

According to a second aspect, there is provided an apparatus for a user equipment, the apparatus comprising means for: receiving, from an access point, signalling of a first configuration for the user equipment to perform at least one measurement for determining a propagation delay for signalling between the user equipment and the access point at a first time and a third time using a first propagation delay mechanism; receiving, from the access point, signalling of a second configuration indicating at least one measurement event for determining a propagation delay for signalling between the user equipment and the access point at a second time using a second propagation delay mechanism, wherein the second time is configured relative to the first time and occurs between the first and third times; performing measurements in accordance with the first and second configurations; signalling an indication of at least one measurement associated with at least one of the first and second configurations to the access point; and receiving at least one modified first configuration and/or modified second configuration.

The apparatus may comprise means for: determining a first value for a propagation delay for signalling using the first propagation delay mechanism at the first time; and signalling the first value to the access point.

The second configuration may indicate a plurality of times between the first time and the third time for said measurement events.

The modified second configuration may indicate that measurements according to the second configuration should cease.

The modified first configuration may indicate that a time between making measurements associated with the first propagation delay mechanism should increase.

The first propagation delay mechanism may be a round trip time mechanism and the second propagation delay mechanism may be a timing advance mechanism.

The first propagation delay mechanism may provide a more accurate value for a propagation delay between the access point and the user equipment than the second propagation delay mechanism.

The first propagation delay mechanism may comprise more signalling overhead for calculating a propagation delay between the access point and the user equipment than the second propagation delay mechanism.

According to a third aspect, there is provided an apparatus for an access point, the apparatus comprising: at least one processor; and at least one memory comprising code that, when executed by the at least one processor, causes the apparatus to: signal, to a user equipment, a first configuration for the user equipment to perform at least one measurement for determining a propagation delay for signalling between the user equipment and the access point at a first time and a third time using a first propagation delay mechanism; signal, to the user equipment, a second configuration indicating at least one measurement event for determining a propagation delay for signalling between the user equipment and the access point at a second time using a second propagation delay mechanism, wherein the second time is configured relative to the first time and occurs between the first and third times; receive, from the user equipment, an indication of at least one measurement associated with the first and second configurations; determine at least one of an accuracy and a reliability of the second propagation delay mechanism using the received at least one indication of at least one measurement; determine whether to modify the first and/or second configuration in dependence on the determined accuracy and/or reliability; and when it is determined to modify the first and/or second configuration, signal the modified first and/or second configuration to the user equipment.

The apparatus may be caused to determine a first value for a propagation delay for signalling using the first propagation delay mechanism at the first time and at least one measurement associated with the first configuration received from the user equipment.

The receiving may comprise receiving a first value for a propagation delay associated with the first configuration at the first time.

The second configuration may indicate a plurality of times between the first time and the third time for said measurement events.

The apparatus may be caused to determine a second value for a propagation delay using the first propagation delay mechanisms at the third time and at least one measurement associated with the first configuration received from the user equipment.

The receiving may comprise receiving a second value for a propagation delay associated with the first configuration at the third time.

The determining an accuracy of the second propagation delay may comprise: determining a first difference between the first value and the second value; determining a first sum of propagation delay values associated with the second configuration at the plurality of times; and determining an accuracy of the second propagation delay mechanism by comparing a difference between the first difference and said sum to a first threshold.

The determining an accuracy of the second propagation delay may comprise: determining a second sum of propagation delay values associated with the second configuration at the plurality of times using measurements performed by the access point; receiving a third sum of propagation delay values associated with the second configuration at the plurality of times from the user equipment; and determining a reliability of the second delay mechanism by comparing a difference between the second sum and the third sum to a second threshold.

The indication of at least one measurement may comprise a difference between a first difference between the first value and the second value and a first sum of propagation delay values associated with the second configuration at the plurality of times.

The modified second configuration may indicate that measurements according to the second configuration should cease.

The modified first configuration may indicate that a time between making measurements associated with the first propagation delay mechanism should increase.

The first propagation delay mechanism may be a round trip time mechanism and the second propagation delay mechanism may be a timing advance mechanism.

The first propagation delay mechanism may provide a more accurate value for a propagation delay between the access point and the user equipment than the second propagation delay mechanism.

The first propagation delay mechanism may comprise more signalling overhead for calculating a propagation delay between the access point and the user equipment than the second propagation delay mechanism.

According to a fourth aspect, there is provided an apparatus for a user equipment, the apparatus comprising: at least one processor; and at least one memory comprising code that, when executed by the at least one processor, causes the apparatus to: receive, from an access point, signalling of a first configuration for the user equipment to perform at least one measurement for determining a propagation delay for signalling between the user equipment and the access point at a first time and a third time using a first propagation delay mechanism; receive, from the access point, signalling of a second configuration indicating at least one measurement event for determining a propagation delay for signalling between the user equipment and the access point at a second time using a second propagation delay mechanism, wherein the second time is configured relative to the first time and occurs between the first and third times; perform measurements in accordance with the first and second configurations; signal an indication of at least one measurement associated with at least one of the first and second configurations to the access point; and receive at least one modified first configuration and/or modified second configuration.

The apparatus may be caused to: determine a first value for a propagation delay for signalling using the first propagation delay mechanism at the first time; and signalling the first value to the access point.

The second configuration may indicate a plurality of times between the first time and the third time for said measurement events.

The modified second configuration may indicate that measurements according to the second configuration should cease.

The modified first configuration may indicate that a time between making measurements associated with the first propagation delay mechanism should increase.

The first propagation delay mechanism may be a round trip time mechanism and the second propagation delay mechanism may be a timing advance mechanism.

The first propagation delay mechanism may provide a more accurate value for a propagation delay between the access point and the user equipment than the second propagation delay mechanism.

The first propagation delay mechanism may comprise more signalling overhead for calculating a propagation delay between the access point and the user equipment than the second propagation delay mechanism.

According to a fifth aspect, there is provided a method for an apparatus for an access point, the method comprising: signalling, to a user equipment, a first configuration for the user equipment to perform at least one measurement for determining a propagation delay for signalling between the user equipment and the access point at a first time and a third time using a first propagation delay mechanism; signalling, to the user equipment, a second configuration indicating at least one measurement event for determining a propagation delay for signalling between the user equipment and the access point at a second time using a second propagation delay mechanism, wherein the second time is configured relative to the first time and occurs between the first and third times; receiving, from the user equipment, an indication of at least one measurement associated with the first and second configurations; determining at least one of an accuracy and a reliability of the second propagation delay mechanism using the received at least one indication of at least one measurement; determining whether to modify the first and/or second configuration in dependence on the determined accuracy and/or reliability; and when it is determined to modify the first and/or second configuration, signalling the modified first and/or second configuration to the user equipment.

The method may comprise determining a first value for a propagation delay for signalling using the first propagation delay mechanism at the first time and at least one measurement associated with the first configuration received from the user equipment.

The receiving may comprise receiving a first value for a propagation delay associated with the first configuration at the first time.

The second configuration may indicate a plurality of times between the first time and the third time for said measurement events.

The method may comprise determining a second value for a propagation delay using the first propagation delay mechanisms at the third time and at least one measurement associated with the first configuration received from the user equipment.

The receiving may comprise receiving a second value for a propagation delay associated with the first configuration at the third time.

The determining an accuracy of the second propagation delay may comprise: determining a first difference between the first value and the second value; determining a first sum of propagation delay values associated with the second configuration at the plurality of times; and determining an accuracy of the second propagation delay mechanism by comparing a difference between the first difference and said sum to a first threshold.

The determining an accuracy of the second propagation delay may comprise: determining a second sum of propagation delay values associated with the second configuration at the plurality of times using measurements performed by the access point; receiving a third sum of propagation delay values associated with the second configuration at the plurality of times from the user equipment; and determining a reliability of the second delay mechanism by comparing a difference between the second sum and the third sum to a second threshold.

The indication of at least one measurement may comprise a difference between a first difference between the first value and the second value and a first sum of propagation delay values associated with the second configuration at the plurality of times.

The modified second configuration may indicate that measurements according to the second configuration should cease.

The modified first configuration may indicate that a time between making measurements associated with the first propagation delay mechanism should increase.

The first propagation delay mechanism may be a round trip time mechanism and the second propagation delay mechanism may be a timing advance mechanism.

The first propagation delay mechanism may provide a more accurate value for a propagation delay between the access point and the user equipment than the second propagation delay mechanism.

The first propagation delay mechanism may comprise more signalling overhead for calculating a propagation delay between the access point and the user equipment than the second propagation delay mechanism.

According to a sixth aspect, there is provided a method for an apparatus for a user equipment, the method comprising: receiving, from an access point, signalling of a first configuration for the user equipment to perform at least one measurement for determining a propagation delay for signalling between the user equipment and the access point at a first time and a third time using a first propagation delay mechanism; receiving, from the access point, signalling of a second configuration indicating at least one measurement event for determining a propagation delay for signalling between the user equipment and the access point at a second time using a second propagation delay mechanism, wherein the second time is configured relative to the first time and occurs between the first and third times; performing measurements in accordance with the first and second configurations; signalling an indication of at least one measurement associated with at least one of the first and second configurations to the access point; and receiving at least one modified first configuration and/or modified second configuration.

The method may comprise: determining a first value for a propagation delay for signalling using the first propagation delay mechanism at the first time; and signalling the first value to the access point.

The second configuration may indicate a plurality of times between the first time and the third time for said measurement events.

The modified second configuration may indicate that measurements according to the second configuration should cease.

The modified first configuration may indicate that a time between making measurements associated with the first propagation delay mechanism should increase.

The first propagation delay mechanism may be a round trip time mechanism and the second propagation delay mechanism may be a timing advance mechanism.

The first propagation delay mechanism may provide a more accurate value for a propagation delay between the access point and the user equipment than the second propagation delay mechanism.

The first propagation delay mechanism may comprise more signalling overhead for calculating a propagation delay between the access point and the user equipment than the second propagation delay mechanism.

According to a seventh aspect, there is provided an apparatus for an access point, the apparatus comprising: signalling circuitry for signalling, to a user equipment, a first configuration for the user equipment to perform at least one measurement for determining a propagation delay for signalling between the user equipment and the access point at a first time and a third time using a first propagation delay mechanism; signalling circuitry for signalling, to the user equipment, a second configuration indicating at least one measurement event for determining a propagation delay for signalling between the user equipment and the access point at a second time using a second propagation delay mechanism, wherein the second time is configured relative to the first time and occurs between the first and third times; receiving circuitry for receiving, from the user equipment, an indication of at least one measurement associated with the first and second configurations; determining circuitry for determining at least one of an accuracy and a reliability of the second propagation delay mechanism using the received at least one indication of at least one measurement; determining circuitry for determining whether to modify the first and/or second configuration in dependence on the determined accuracy and/or reliability; and when it is determined to modify the first and/or second configuration, signalling circuitry for signalling the modified first and/or second configuration to the user equipment.

The apparatus may comprise determining circuitry for determining a first value for a propagation delay for signalling using the first propagation delay mechanism at the first time and at least one measurement associated with the first configuration received from the user equipment.

The receiving circuitry for receiving may comprise receiving circuitry for receiving a first value for a propagation delay associated with the first configuration at the first time.

The second configuration may indicate a plurality of times between the first time and the third time for said measurement events.

The apparatus may comprise determining circuitry for determining a second value for a propagation delay using the first propagation delay mechanisms at the third time and at least one measurement associated with the first configuration received from the user equipment.

The receiving circuitry for receiving may comprise receiving circuitry for receiving a second value for a propagation delay associated with the first configuration at the third time.

The determining circuitry for determining an accuracy of the second propagation delay may comprise: determining circuitry for determining a first difference between the first value and the second value; determining circuitry for determining a first sum of propagation delay values associated with the second configuration at the plurality of times; and determining circuitry for determining an accuracy of the second propagation delay mechanism by comparing a difference between the first difference and said sum to a first threshold.

The determining circuitry for determining an accuracy of the second propagation delay may comprise: determining circuitry for determining a second sum of propagation delay values associated with the second configuration at the plurality of times using measurements performed by the access point; receiving circuitry for receiving a third sum of propagation delay values associated with the second configuration at the plurality of times from the user equipment; and determining circuitry for determining a reliability of the second delay mechanism by comparing a difference between the second sum and the third sum to a second threshold.

The indication of at least one measurement may comprise a difference between a first difference between the first value and the second value and a first sum of propagation delay values associated with the second configuration at the plurality of times.

The modified second configuration may indicate that measurements according to the second configuration should cease.

The modified first configuration may indicate that a time between making measurements associated with the first propagation delay mechanism should increase.

The first propagation delay mechanism may be a round trip time mechanism and the second propagation delay mechanism may be a timing advance mechanism.

The first propagation delay mechanism may provide a more accurate value for a propagation delay between the access point and the user equipment than the second propagation delay mechanism.

The first propagation delay mechanism may comprise more signalling overhead for calculating a propagation delay between the access point and the user equipment than the second propagation delay mechanism.

According to an eighth aspect, there is provided an apparatus for a user equipment, the apparatus comprising: receiving circuitry for receiving, from an access point, signalling of a first configuration for the user equipment to perform at least one measurement for determining a propagation delay for signalling between the user equipment and the access point at a first time and a third time using a first propagation delay mechanism; receiving circuitry for receiving, from the access point, signalling of a second configuration indicating at least one measurement event for determining a propagation delay for signalling between the user equipment and the access point at a second time using a second propagation delay mechanism, wherein the second time is configured relative to the first time and occurs between the first and third times; performing circuitry for performing measurements in accordance with the first and second configurations; signalling circuitry for signalling an indication of at least one measurement associated with at least one of the first and second configurations to the access point; and receiving circuitry for receiving at least one modified first configuration and/or modified second configuration.

The apparatus may comprise: determining circuitry for determining a first value for a propagation delay for signalling using the first propagation delay mechanism at the first time; and signalling circuitry for signalling the first value to the access point.

The second configuration may indicate a plurality of times between the first time and the third time for said measurement events.

The modified second configuration may indicate that measurements according to the second configuration should cease.

The modified first configuration may indicate that a time between making measurements associated with the first propagation delay mechanism should increase.

The first propagation delay mechanism may be a round trip time mechanism and the second propagation delay mechanism may be a timing advance mechanism.

The first propagation delay mechanism may provide a more accurate value for a propagation delay between the access point and the user equipment than the second propagation delay mechanism.

The first propagation delay mechanism may comprise more signalling overhead for calculating a propagation delay between the access point and the user equipment than the second propagation delay mechanism.

According to a ninth aspect, there is provided non-transitory computer readable medium comprising program instructions for causing an apparatus for an access point to perform at least the following: signal, to a user equipment, a first configuration for the user equipment to perform at least one measurement for determining a propagation delay for signalling between the user equipment and the access point at a first time and a third time using a first propagation delay mechanism; signal, to the user equipment, a second configuration indicating at least one measurement event for determining a propagation delay for signalling between the user equipment and the access point at a second time using a second propagation delay mechanism, wherein the second time is configured relative to the first time and occurs between the first and third times; receive, from the user equipment, an indication of at least one measurement associated with the first and second configurations; determine at least one of an accuracy and a reliability of the second propagation delay mechanism using the received at least one indication of at least one measurement; determine whether to modify the first and/or second configuration in dependence on the determined accuracy and/or reliability; and when it is determined to modify the first and/or second configuration, signal the modified first and/or second configuration to the user equipment.

The apparatus may be caused to determine a first value for a propagation delay for signalling using the first propagation delay mechanism at the first time and at least one measurement associated with the first configuration received from the user equipment.

The receiving may comprise receiving a first value for a propagation delay associated with the first configuration at the first time.

The second configuration may indicate a plurality of times between the first time and the third time for said measurement events.

The apparatus may be caused to determine a second value for a propagation delay using the first propagation delay mechanisms at the third time and at least one measurement associated with the first configuration received from the user equipment.

The receiving may comprise receiving a second value for a propagation delay associated with the first configuration at the third time.

The determining an accuracy of the second propagation delay may comprise: determining a first difference between the first value and the second value; determining a first sum of propagation delay values associated with the second configuration at the plurality of times; and determining an accuracy of the second propagation delay mechanism by comparing a difference between the first difference and said sum to a first threshold.

The determining an accuracy of the second propagation delay may comprise: determining a second sum of propagation delay values associated with the second configuration at the plurality of times using measurements performed by the access point; receiving a third sum of propagation delay values associated with the second configuration at the plurality of times from the user equipment; and determining a reliability of the second delay mechanism by comparing a difference between the second sum and the third sum to a second threshold.

The indication of at least one measurement may comprise a difference between a first difference between the first value and the second value and a first sum of propagation delay values associated with the second configuration at the plurality of times.

The modified second configuration may indicate that measurements according to the second configuration should cease.

The modified first configuration may indicate that a time between making measurements associated with the first propagation delay mechanism should increase.

The first propagation delay mechanism may be a round trip time mechanism and the second propagation delay mechanism may be a timing advance mechanism.

The first propagation delay mechanism may provide a more accurate value for a propagation delay between the access point and the user equipment than the second propagation delay mechanism.

The first propagation delay mechanism may comprise more signalling overhead for calculating a propagation delay between the access point and the user equipment than the second propagation delay mechanism.

According to a tenth aspect, there is provided non-transitory computer readable medium comprising program instructions for causing an apparatus for a user equipment to perform at least the following: receive, from an access point, signalling of a first configuration for the user equipment to perform at least one measurement for determining a propagation delay for signalling between the user equipment and the access point at a first time and a third time using a first propagation delay mechanism; receive, from the access point, signalling of a second configuration indicating at least one measurement event for determining a propagation delay for signalling between the user equipment and the access point at a second time using a second propagation delay mechanism, wherein the second time is configured relative to the first time and occurs between the first and third times; perform measurements in accordance with the first and second configurations; signal an indication of at least one measurement associated with at least one of the first and second configurations to the access point; and receive at least one modified first configuration and/or modified second configuration.

The apparatus may be caused to: determine a first value for a propagation delay for signalling using the first propagation delay mechanism at the first time; and signalling the first value to the access point.

The second configuration may indicate a plurality of times between the first time and the third time for said measurement events.

The modified second configuration may indicate that measurements according to the second configuration should cease.

The modified first configuration may indicate that a time between making measurements associated with the first propagation delay mechanism should increase.

The first propagation delay mechanism may be a round trip time mechanism and the second propagation delay mechanism may be a timing advance mechanism.

The first propagation delay mechanism may provide a more accurate value for a propagation delay between the access point and the user equipment than the second propagation delay mechanism.

The first propagation delay mechanism may comprise more signalling overhead for calculating a propagation delay between the access point and the user equipment than the second propagation delay mechanism.

According to an eleventh aspect, there is provided a computer program comprising program instructions for causing a computer to perform any method as described above.

According to a twelfth aspect, there is provided a computer program product stored on a medium that may cause an apparatus to perform any method as described herein.

According to a thirteenth aspect, there is provided an electronic device that may comprise apparatus as described herein.

### BRIEF DESCRIPTION OF FIGURES

Examples will now be described, by way of example only, with reference to the accompanying Figures in which:

FIG. 1 shows a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 illustrates an example system;

FIG. 6 is a schematic diagram illustrating a user equipment architecture diagram for a user equipment in communication with an access point/gNB;

FIG. 7 is a schematic diagram illustrating operations that may be performed by the estimation function of FIG. 6;

FIGS. 8 and 9 illustrate example signalling that may be performed;

FIG. 10 illustrates timing of signalling and/or operations performed by apparatus described herein; and

FIGS. 11 and 12 are flow charts illustrating potential operations that may be performed by apparatus described herein.

### DETAILED DESCRIPTION

In the following, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems with analogous components (for example, in the upcoming 6G communication system).

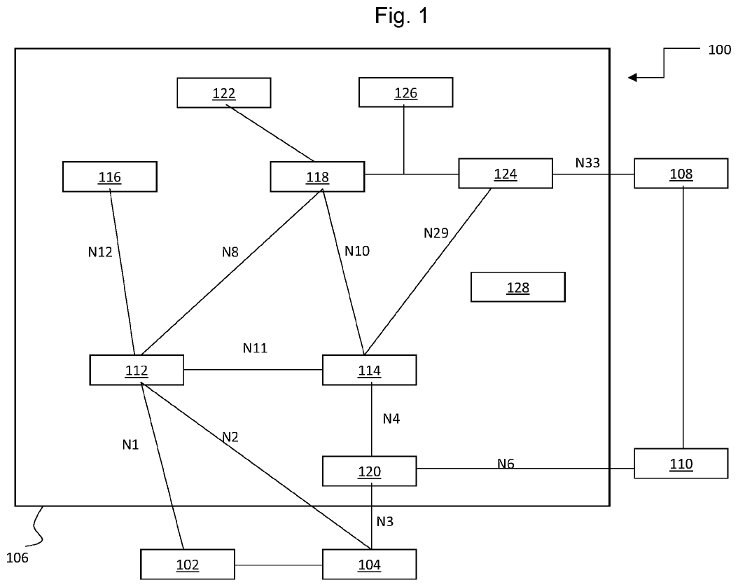

Before explaining in detail the exemplifying embodiments, certain general principles of a 5G wireless communication system are briefly explained with reference to FIG. 1.

FIG. 1 shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

3GPP refers to a group of organizations that develop and release different standardized communication protocols. 3GPP is currently developing and publishing documents related to Release 16, relating to 5G technology, with Release 17 currently being scheduled for 2022.

Accurate time synchronization was introduced in Release-16 of the 3GPP 5G New Radio specifications in order to support Industrial Internet of Things (IIoT) use-cases and, in particular, to support Time Sensitive Networking (TSN) or Time Sensitive Communications (TSC) applications.

TSN is a set of open standards specified by IEEE 802.1 that were primarily developed for IEEE Std 802.3 Ethernet applications. Part of these standards are included to enable time synchronization across such a network. The TSN tool for time synchronization is the generalized Precision Time Protocol (gPTP), which is a profile of the Precision Time Protocol standard (IEEE 1588). The gPTP provides reliable time synchronization, which can be used by other TSN tools, such as Scheduled Traffic (802.1Qbv).

When the 5G System (5GS) and the TSN system are combined, the 5G system (5GS) may appear from the rest of the network to be a set of TSN bridges, with one virtual TSN bridge per User Plane Function (UPF). The 5GS may include TSN translator functionality for translating between the 5GS and the TSN domain, both for the user plane and the control plane. Such TSN translator (TT) functionality may hide the 5GS internal procedures from the TSN network.

Time synchronization is a key component in all cellular networks. Providing time synchronization in a 5G-TSN combined industrial deployment brings in new aspects. In most cases, end devices need time references, while bridges using a TSN feature that is based on time, such as Scheduled Traffic (802.1Qbv) may also need time references.

Time synchronization helps to ensure that different nodes of a 5G network (e.g. UPF, gNB, UE) share the same Time of Day (ToD) clock, such as the coordinated universal time (UTC) clock. The work on time synchronization continues in Release-17 as part of various Radio Access Network (RAN) working groups (e.g. RAN1, RAN2, RAN3) and studies.

One of the objectives related to time synchronization is to determine enhancements that may be made to propagation delay compensation (including any mobility issues) in support of time synchronization, so that propagation delay (e.g. the time taken for a signal to be sent from a transmitter to a recipient) can be taken into account when determining a transmission time for a signal.

The different RAN working groups have been focusing on different parts of these objectives. For example, the focus from RAN2 side has been on the signalling and the time synchronization accuracy budget over the interface between a user equipment (UE) and the RAN (e.g. over the Uu interface). Further, RAN1 has focused on analyzing the achievable accuracy of propagation delay estimation techniques, while RAN3 has focused on implications of gNB-based propagation delay compensation.

RAN1 has proposed some options for propagation delay compensation that may impact the study of RAN2.

The first set of options relate to the use of Timing Advance based (TA-based) mechanisms for determining a propagation delay.

For example, for a first option, the propagation delay estimation may be performed based on existing legacy Timing Advance mechanisms.

Timing Advance mechanisms determine the length of a delay along a single transmission leg extending between a transmitter and a receiver. Timing Advance mechanisms are currently described in 3GPP Technical Specifications TS 38.133, TS 38.213 and TS 38.321. These specifications describe how to obtain a Timing Advance value for adjusting a transmission time of a user equipment to account for the length of time a signal takes to reach an access point from a user equipment. In more detail, each user equipment is assigned a particular time to transmit, and the access point determines the distance between the transmitting user equipment and itself by knowing the time at which that user equipment made the transmission and the speed of radio waves. The access point may then determine a Timing Advance value for that transmitting user equipment. The Timing Advance value is a variable value used for adjusting a transmission time of the user equipment to account for this propagation time between the user equipment and the access point (i.e. for performing propagation delay compensation). The Timing Advance is a Round Trip Time (RTT) estimate as an access point/gNB measures how far off the uplink transmission is from the downlink frame time. The propagation delay can then be estimated by dividing the timing advance value by 2.

As a second option, the propagation delay estimation may be performed based on a modified version of current Timing Advance mechanisms. The modification may be, for example, to enhance timing synchronization, such as an adjustment to the Timing Advance adjustment value and a Timing Error, Te, requirement for an initial transmission. The Timing error requirement is currently defined in 3GPP TS 38.133.

As a third option, the propagation delay estimation may be performed based on a new dedicated signalling that provides a finer delay compensation granularity that Timing Advance mechanisms, such that the current Timing Advance mechanism is not affected. However, the determination of the delay is still determined using a single leg/single transmission.

The second set of options relate to Round-Trip-Time (RTT)-based delay compensation. For example, the propagation delay estimation may be performed based on RAN-managed transmit-receive procedures intended for time synchronization, although it is for future study how this is to be implemented. These Round-Trip-Time propagation estimates consider the length of time taken for both a signal to be transmitted to a receiver, and for the receiver to transmit a signal back again. Reference to transmit-receive procedures in the following will be understood to relate to RTT-based propagation delay measurements. It is further understood that although current transmit-receive procedures for determining an RTT-based propagation delay are directed towards positioning mechanisms, alternate mechanisms for determining an RTT may be used. For example, a variation of the present positioning-related techniques may be adapted for propagation delay for time synchronization.

Due to the dynamic nature of the radio link, it is challenging to deliver time synchronization over the interface from the gNB to the UE (e.g. over the Uu interface). Using the 5G NR control plane, time synchronization information (such as, for example, the gNB clock) can be delivered from a gNB to UEs served by the gNB using at least broadcast and/or unicast transmission. For example, when broadcast, the time information may be encoded in a System Information Broadcast (SIB) message, such as a SIB9 message that's currently defined in 3GPP. As another example, when unicast, the time information may be encoded in a unicast Radio Resource Control (RRC) message.

Regardless of whether unicast or broadcast transmission is used, the encoded time information in each message is the gNB's clock time corresponding to the ending boundary of a specific radio system frame number (refSFN), where refSFN is indicated to the UE either implicitly (in case of broadcast) or explicitly (in case of unicast). When a UE receives the message comprising the encoded time information, the UE associates the time information with its own refSFN boundary, which is aligned with the gNB's refSFN boundary. In this way, underlying 5G radio frame timing at gNB and UE can be used as a common reference for delivery of ToD clock.

A challenge in using the underlying 5G radio frame timing at gNB and UE as a common reference for delivery of Time of Day clock is that radio frame boundaries (herein referred to as refSFN boundaries) at the gNB and the UE are not perfectly aligned in time with respect to one another. In particular, downlink frame boundaries at the UE are shifted by the propagation delay (i.e. by the time it takes for radio frame to propagate from gNB to UE over the air) with respect to the corresponding frame boundary at gNB. When a UE synchronizes its clock by associating time information carried by the gNB message with its own refSFN boundary, the UE's clock will be delayed by propagation delay compared to gNB's clock. This is not an issue when the interface budget between the gNB and the UE is sufficiently large, compared to the maximum experienced propagation delay. The term “interface budget” refers, in the present context, to a maximum tolerable error for time synchronization, and is also referred to as a “Time synchronization error budget”. End-to-end requirements/budgets may be specified by particular 3GPP working groups before being translated into a Radio Access Network (RAN)/Uu interface budgets.

For small, indoor scenarios, the propagation delay might not be an issue (as 10 m adds 33 ns). However, for larger cells, such as a smart grid scenario, or for a very tight interface budget requirement (e.g. <300 ns, which may be agreed in Rel-17 by RAN2 or will be introduced in Rel-18), the UE needs to compensate the time information received in the message to account for the propagation delay. This may be done, for example, by adding a current propagation time estimate to the time information.

Acquisition of a propagation delay estimation uses a measurement of the propagation delay, which is typically estimated from an RTT measurement as this is more accurate than Timing Advance mechanisms. This can be obtained using the positioning framework (multi-RTT procedure as described in TS 38.215) or through the UE Timing Advance mechanism. Currently, the best estimation for the downlink propagation delay from an RTT estimation is to divide the measured RTT by two. However, the by far largest benefit of Timing Advance for propagation delay compensation is to align uplink transmissions to avoid inter-symbol interference in the uplink (keeping uplink transmissions within the cyclic prefix).

The receive-transmit-based propagation delay estimation has the benefit over the Timing Advance based propagation delay estimation in that it provides an unbiased RTT estimation and is subject to much stricter performance requirements at the device. A receive-transmit based propagation delay estimation will be capable of achieving higher accuracies than a Timing Advance based option in a single-shot estimation. However, the drawback of a receive-transmit based propagation delay estimation procedure is the signaling overhead used for signalling the receive-transmit measurement, which can be considered as 100% overhead when the Timing Advance procedure is actually sufficiently accurate. Even though both RTT and Timing Advance may ultimately produce an RTT estimation, they are not currently linked in any way.

There are a couple of challenges with using Timing Advance for propagation delay estimation.

For example, the gNB is not mandated to track Timing Advance relative to a perfectly aligned uplink and downlink frame timing, and the gNB may shift the uplink transmissions slightly if wanted.

Further, the UE performance requirements for Timing Advance applications and implementation is not particularly strict compared to the requirements in some envisioned propagation delay scenarios (e.g. 250 ns as proposed for R18 scenarios).

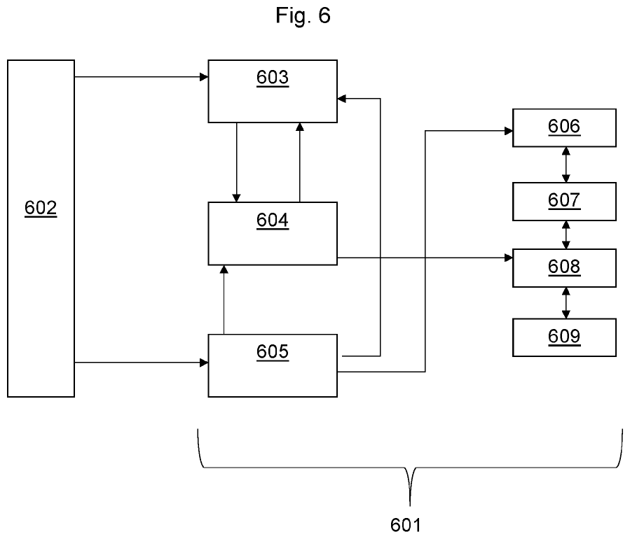

The following considers how the UE keeps track of time in Release 16 with reference to FIG. 6.

FIG. 6 is a schematic diagram illustrating a UE architecture diagram for a UE 601 in communication with a gNB/access point 602 that has time sensitive network (TSN) capabilities.

The UE 601 is configured with an estimation function 603 for estimating a time and frequency reference level. This estimation function receives carrier frequency and sequence frame number timing over an interface from the access point 602. The estimated frequency update is provided to a propagation delay compensated network clock 604 along with an estimated RTT for the signalling between the UE 601 and the access point 602. The network clock 604 provides a Time of Day (ToD) and/or pulse-per-second (PPS) to the estimation function 603 for use in the estimation. The estimation function 603 also provides the estimated frequency update to an absolute time tracker 605. The absolute time tracker 605 receives signalling from the access point 602 and maintains reference time information. The absolute time tracker 605 provides information on the ToD to the network clock 604. The absolute time tracker 605 provides the ToD and/or PPS to a Precision Time Protocol (PTP) layer 606. The PTP stack 606 is defined by IEEE specifications as part of the TSN definitions. The PTP stack 606 is in communication with a media access layer 607, which is in turn in communication with a Time Stamping Unit (TSU) layer 608, which is in turn in contact with a physical layer 609. The TSU layer is associated with the PTP layer, and is defined in IEEE in relation to TSNs. The network clock 604 provides the ToD and/or PPS to the TSU layer 608.

The features of a DS-TT are therefore embedded in the UE 601 through the presence of the TSN-related protocol stacks, PTP layer 606 and TSU layer 608. The UE 601 has two interfaces from the access point 602. The first interface is an air interface from which the UE can measure the System frame number timing and the System frame number boundary locations, along with tracking the carrier frequency. The second interface is a Synchronization-plane interface from which the UE may acquire reference Time information (from, for example, either broadcast or unicast signalling, as described above). The Synchronization-plane relates to aspects to do with time synchronization, e.g. PTP configuration, System Information Block 9 (SIB9), etc. The Synchronization-plane comprises both control-plane (C-plane) and user-plane (U-plane) aspects, with gPTP messages being transmitted over the control plane.

The estimation function 603 uses signalling over the air interface to provide the UE clock reference, and so also provides propagation delay estimation tracking and any frequency corrections/updates to the network clock 604. The network clock 604 at the UE is used to timestamp gPTP packets for 5GS residence time compensation, and is also the input to the vertical clock domain tracking entity absolute time tracker 605. The absolute time tracker 605 may track either a local clock (vertical clock not being the same time domain as the network clock 604), or the network clock 604. In the latter case, the absolute time tracker 605 may also act as a gateway to the gPTP protocol stack.

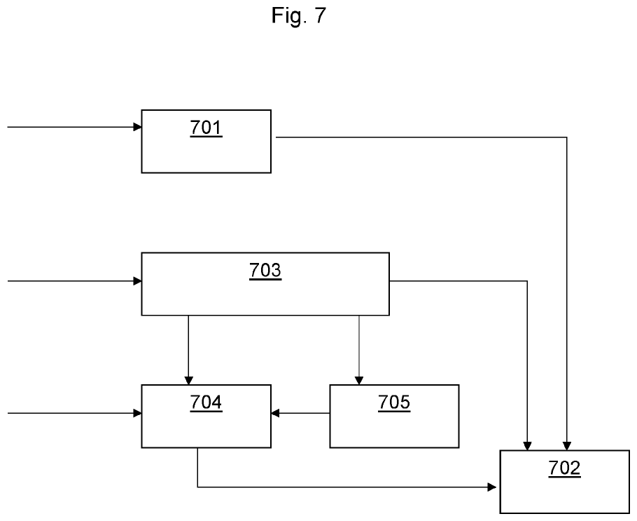

FIG. 7 is a schematic diagram illustrating more operations that may be performed by the estimation function 603.

FIG. 7 shows a frequency tracker 701 that is configured to receive a carrier frequency over an air interface and to determine a frequency offset over time. The determined frequency offset may be provided to a network clock tracker 702.

FIG. 7 further shows a time tracker 703 that receives signalling over the air interface and performs both fine and coarse time estimation for all of the received signals. Coarse time estimation may be performed, for example, using symbol timing, while fine time estimation may be performed using, for example, a primary synchronization signal, the demodulation reference signal and/or data. The time tracker 703 outputs time update information based on at least one of the fine and coarse estimations to the network clock tracker 702.

The time tracker 703 may additionally output the time update information to each of an uplink time tracker 704 and an adjustment unit 705. The adjustment unit 705 determines whether there is a path change in the received signalling and, if so, signals the uplink time tracker 704 to adjust Timing Advance information. The uplink time tracker 704 is configured to track the uplink transmission time relative to the gNB configured Timing Advance value (sometimes also referred to as NTA) and a detected downlink reception timing. The uplink time tracker 704 receives all of this signalling, in addition to Timing Advance signalling, and calculates a round trip time for the received signalling. This round trip time in then output from the uplink time tracker 704 to the network clock tracker 702.

As mentioned above, the Timing Advance procedure currently used in 5G NR is not guaranteed to provide a sufficiently accurate propagation delay estimation for the desired use cases as the gNB is not mandated to perfectly align uplink and downlink frame timing and because the UE performance requirements are not very strict relative to Release 18 accurate time synchronization scenarios. Timing Advance is, however, a mandatory feature so if it is feasible to utilize, it will not cause additional air interface activity, contrary to a receive-transmit based propagation delay estimation procedure for estimating round trip time. A standard gNB and UE implementation would resort to the using the most accurate procedure (i.e. namely the receive-transmit-based propagation delay estimation) regardless of the higher radio resource overhead resulting from this procedure.

Attempts have been made to integrate these two different sets of mechanisms. For example, the network may be able to flexibly configure uplink and downlink reference signals to be used in the receive-transmit-based procedure measurement, while also having the option to decide whether to use either the receive-transmit/round trip time procedure, or the existing Timing Advance procedure. However, no disclosure has been made regarding how the UE may function to best utilize the information from the Timing Advance procedure to minimize the use of a receive-transmit-based procedure.

To address at least one of the above-mentioned issues, the following discloses a mechanism in which a Timing Advance procedure is utilized to track propagation delay (PD) adjustments relative to an absolute propagation delay estimation achieved by a receive-transmit based propagation delay estimation procedure. In other words, a first propagation delay is determined using a first mechanism, before a second propagation delay is determined using a second mechanism, wherein the second mechanism is less accurate than the first mechanism. The combination of the first and second propagation delays may be used to determine a propagation delay for compensating for uplink and/or downlink transmissions and/or receptions.

Tracking propagation delay adjustments relative to the propagation delay estimation achieved by a receive-transmit based propagation delay estimation procedure minimizes the need for making receive-transmit measurements as interim Timing Advance commands may be used as a basis for propagation delay updates at the UE instead. A timing advance command can be carried in a second message in the Physical Random Access Channel (PRACH) or in a Medium Access Control (MAC) Control Element (CE) (when the UE receiving the second message is in an RRC-Connected mode). NTA, which is the quantitation of TA values, may be signalled to effect this. When NTA is signaled in a MAC CE, it may be signalled by indicating a relative “up” or “down” step compared to a previous NTA value. In other words, although the NTA may be signalled using an absolute value, the NTA may be signalled using a relative (e.g. “higher” or “lower” than the NTA value used immediately previously). The NTA value may be scaled to a TA timing offset using a predetermined algorithm.

The following further introduces a new UE measurement report that the gNB may use to assess the stability of Timing Advance tracking at the UE side and to determine an optimal combination of receive-transmit and Timing Advance propagation delay estimation events. This may reduce system resource usage while ensuring high propagation delay tracking accuracy at the UE and hence also enable high synchronization accuracy in wide-area deployment with propagation delay compensation.

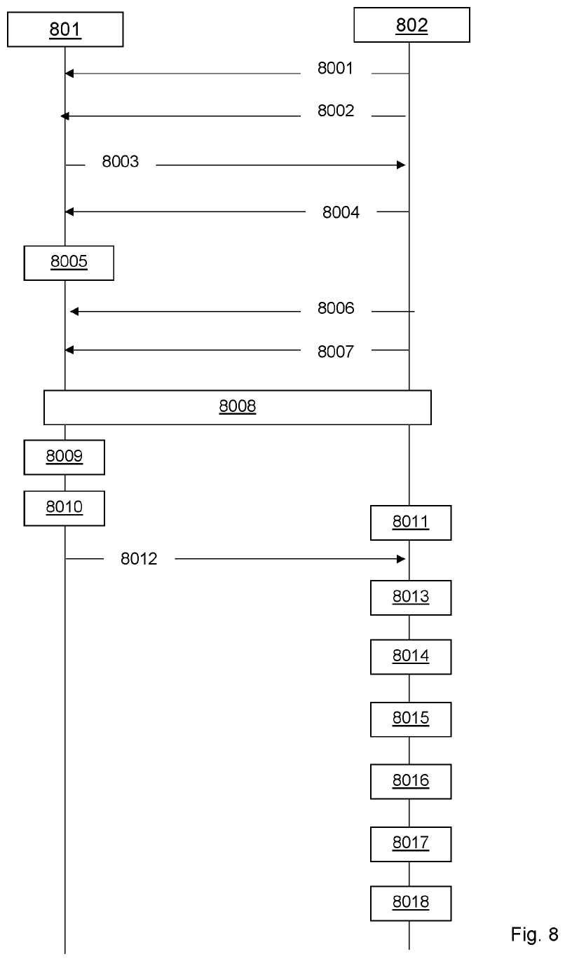

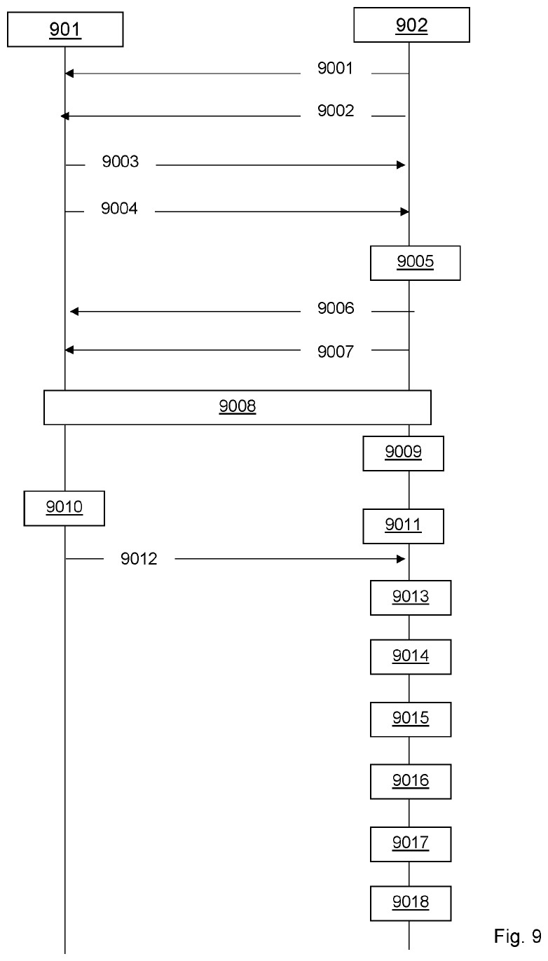

FIGS. 8 and 9 are flow charts illustrating potential operations that may be performed in accordance with the presently disclosed mechanisms. They thus provide examples of how the general techniques may be implemented in different ways.

FIG. 8 illustrates signalling that may be performed between a UE 801 and a gNB/access point 802.

Steps 8001 to 8005 relate to mechanism for the gNB 802 to configure the UE 801 with a receive-transmit-based propagation delay estimation event.

At 8001, the gNB 802 signals a configuration to the UE 801 for configuring the UE 801 to recognize a receive-transmit-based propagation delay estimation on which to calculate a round trip time.

Steps 8002 to 8005 relate to a receive-transmit measurement procedure being performed for a first round trip time calculation/measurement.

At 8002, the gNB 802 signals a downlink reference signal to the UE 801. This downlink reference signal may be, for example, a Primary Reference Signal.

At 8003, the UE 801 signals an uplink reference signal to the gNB 802. This uplink reference signal may be, for example, a Sounding Reference Signal.

At 8004, the gNB 802 signals a receive-transmit measurement for the uplink reference signal of 8003 to the UE 801.

At 8005, the UE 801 computes a first round trip time value for the combination of uplink and downlink reference signal transmissions of 8002 and 8003 using the receive-transmit measurement of 8004. The Round Trip Time may be labelled as (RTT_rxtx(t1)), where t1 is a known common reference time for the UE and the gNB.

At 8006, the gNB 802 signals a configuration instruction to the UE 801 that, on receipt by the UE 801, configures the UE to track relative Timing Advance adjustments from the last receive-transmit measurement event (i.e. from the value computed at 8005).

At 8007, the gNB 802 signals a configuration instruction to the UE 801 that, on receipt by the UE 801, configures the UE with measurement events that may be used to perform the tracking configured in 8006. As examples, the gNB 802 may signal or otherwise indicate individual measurements to be made, calculations as part of the report, and/or signal that any subsequent measurement report may be based on a configured threshold or other filtering parameters. The measurement report may be filtered so that it is only transmitted when certain conditions are met. For example, the measurement report may be transmitted in dependence on a certain offset threshold value based on a timer being met since the last measurement report was transmitted. The measurement (and consequently transmission of the measurement report) may also be configured to be between non-consecutive receive-transmit events for longer-term monitoring.

The gNB may use these configurations of 8006 to 8007 to optimize receive-transmit events and Timing Advance patterns in order to minimize the effect of Timing Advance granularity on the measuring report accuracy.

At 8008, the UE 801 and gNB 802 repeat the process of steps 8002 to 8005 to compute a second round trip time value. The time at which this second round trip time value is calculated may be a value known to both the UE and the gNB. The second Round Trip Time may be labelled as (RTT_rxtx(t2)), where t2 is a known common reference time for the UE and the gNB.

At 8009, the UE 801 determines a difference between the times the first and second round trip time values. The difference may be labelled as Drxtx(t1,t2), where Drxtx(t1,t2)=RTT_rxtx(t1)−RTT_rxtx(t2). It is understood that although this step is shown as being performed by the UE 801, that this step may instead be evaluated by the gNB 802. In general, 8009 may be performed by the entity that collects the receive-transmit based round trip time measurements.

At 8010, the UE 801 determines a sum of the relative timing adjustment steps received between the times the first and second round trip time values were calculated. This sum may be labelled as Dtarx(t1,t2), where Dtarx(t1,t2)=Σₜ₌ₜ₁^{t2} TArx(t), and where TArx(t) is the relative Timing Advance step received at time t and converted to an equivalent time unit (e.g. seconds unit).

At 8011, the gNB 802 determines a sum of the relative timing adjustment steps transmitted to the UE 801 between the times the first and second round trip time values were calculated. This sum may be labelled as Dtatx(t1,t2), where Dtatx(t1,t2)=Σₜ₌ₜ₁^{t2} TAtx(t), and where TArx(t) is the relative Timing Advance step received at time t and converted to an equivalent time unit (e.g. seconds unit).

At 8012, the UE 801 signals an indication of the results of the determinations of 8009 and 8010 to the gNB 802. To do this, the UE 801 may signal the actual values determined in 8009 and 8010. The UE may additionally or alternatively provide the indication of 8012 by signalling a difference between the values determined in 8009 and 8010. In other words, the UE may signal Dtarx(t1,t2), and/or Drxtx(t1,t2), and/or Dtarx(t1,t2)−Drxtx(t1,t2).

The signalling may be provided in a measurement report. The measurement report may be filtered, for example, conditioned on certain offset threshold value of based on timer since the last measurement report was provided. The measurement report may also be configured to be signalled between non-consecutive receive-transmit events for longer-term monitoring.

Steps 8013 and 8014 relate to the gNB determining an accuracy of the TA relative to the round trip time measurements. This accuracy refers to a consistency/stability of the TA mechanism.

At 8013, the gNB 802 determines a difference between the values determined in 8009 and 8010 if this was not signalled by the UE 801 in 8012. The gNB may additionally or alternatively use proprietary Timing Advance tracking mechanisms to determine an accuracy for the Timing Advance accuracy evaluation. As one example of a proprietary Timing Advance tracking mechanism, a UE may comprise some means of knowing its own position (e.g. through Global Positioning System (GPS) signals), and may track how much the Timing Advance value changes with changes in the UE position and/or when the UE has not moved.

At 8014, the gNB 802 determines whether the Timing Advance mechanism is inaccurate (e.g. whether the difference between the values determined in 8009 and 8010 is above an accuracy threshold value). When the Timing Advance mechanism is determined to be inaccurate, the gNB 802 may initiate enhancement procedures for improving the accuracy of the Timing Advance procedures. When the Timing Advance mechanism is determined to be accurate, the gNB 802 does not initiate enhancement procedures for improving the accuracy of the Timing Advance procedures.

There are a number of ways in which the Timing Advance procedure may be made more accurate. For example, the accuracy may be increased by increasing the rate at which updates are performed, improving a Time of Arrival (ToA) estimation algorithm, decreasing the time between receive-transmit events, and/or disabling of the UE use of Timing Advance for interim adjustments between receive-transmit events.

Steps 8015 to 8016 relate to the gNB 802 determining a reliability of the Timing Advance procedure applied by the gNB 802 relative to the UE 801.

At 8015, the gNB 802 calculates a difference between the values determined at 8010 and 8011. The gNB may additionally or alternatively use proprietary Timing Advance tracking mechanisms to estimate at least one reasons for the different in Timing Advance offsets. For example, there may be differences when different or unreliable mechanisms are employed, such as unreliable (or insufficient reliable) physical downlink control channel, an unreliable physical downlink shared channel, and/or differences in Timing Advance mechanisms.

At 8016, the gNB 802 determines whether the Timing Advance mechanism is unreliable (e.g. if the value calculated in 8015 is above a reliability threshold value). When the Timing Advance mechanism is determined to be unreliable, this implies that the UE 801 is not receiving Timing Advance events properly. Therefore, the reliability of Timing Advance transmissions may be improved when the gNB determines that the Timing Advance mechanism is unreliable. The gNB may make no change to the reliability of Timing Advance transmissions when it is determined that the Timing Advance mechanism is reliable.

At 8017, assuming that the Timing Advance mechanism is determined to be accurate and reliable, the gNB 802 reduces the occurrence rate of round trip time measurements such as 8002-8005 so that they occur less frequently. The Timing Advance mechanism may be determined to be both accurate and reliable following a repetition of steps 8001 to 8016 until the Timing Advance is determined to be both accurate and reliable. The use of the Timing Advance mechanisms may be dropped if the Timing Advance mechanism is still determined to be inaccurate and/or unreliable after a predetermined number of steps 8001 to 8016.

FIG. 9 is a flow charts illustrating potential operations that may be performed in accordance with the presently disclosed mechanisms.

FIG. 9 illustrates signalling that may be performed between a UE 901 and a gNB/access point 902. FIG. 9 differs from the example of FIG. 8 in that it is the gNB in FIG. 9 that performs the round-trip-time calculation instead of the UE (as per FIG. 8).

Steps 9001 to 9005 relate to mechanism for the gNB 902 to configure the UE 901 with a receive-transmit-based propagation delay estimation event.

At 9001, the gNB 902 signals a configuration to the UE 901 for configuring the UE 901 to recognize a receive-transmit-based propagation delay estimation on which to calculate a round trip time.

Steps 9002 to 9005 relate to a receive-transmit measurement procedure being performed for a first round trip time calculation/measurement.

At 9002, the gNB 902 signals a downlink reference signal to the UE 801. This downlink reference signal may be, for example, a Primary Reference Signal transmitted by the gNB 902.

At 9003, the UE 901 signals an uplink reference signal to the gNB 902. This uplink reference signal may be, for example, a Sounding Reference Signal.

At 9004, the UE 901 signals a receive-transmit measurement for the uplink reference signal of 9002 to the gNB 902.

At 9005, the gNB 902 computes a first round trip time value for the combination of uplink and downlink reference signal transmissions of 9002 and 9003 using the receive-transmit measurement of 9004. The Round Trip Time may be labelled as (RTT_rxtx(t1)), where t1 is a known common reference time for the UE and the gNB.

At 9006, the gNB 902 signals a configuration instruction to the UE 901 that, on receipt by the UE 901, configures the UE to track relative Timing Advance adjustments from the last receive-transmit measurement event (i.e. from the value computed at 9005).

At 9007, the gNB 902 signals a configuration instruction to the UE 901 that, on receipt by the UE 901, configures the UE with measurement events that may be used to perform the tracking configured in 9006. As examples, the gNB 902 may signal or otherwise indicate individual measurements to be made, calculations as part of the report, and/or signal that any subsequent measurement report may be based on a configured threshold or other filtering parameters. The measurement report may be filtered so that it is only transmitted when certain conditions are met. For example, the measurement report may be transmitted in dependence on a certain offset threshold value of based on timer being met since the last measurement report was transmitted. The measurement (and consequently transmission of the measurement report) may also be configured to be between non-consecutive receive-transmit events for longer-term monitoring.

The gNB may use these configurations of 9006 to 9007 to optimize receive-transmit events and Timing Advance patterns in order to minimize the effect of Timing Advance granularity on the measuring report accuracy.

At 9008, the UE 901 and gNB 902 repeat the process of steps 9002 to 9005 to compute a second round trip time value. The time at which this second round trip time value is calculated may be a value known to both the UE and the gNB. The second Round Trip Time may be labelled as (RTT_rxtx(t2)), where t2 is a known common reference time for the UE and the gNB.

At 9009, the gNB 902 determines a difference between the times the first and second round trip time values. The difference may be labelled as Drxtx(t1,t2), where Drxtx(t1,t2)=RTT_rxtx(t1)−RTT_rxtx(t2).

At 9010, the UE 901 determines a sum of the relative timing adjustment steps received between the times the first and second round trip time values were calculated. This sum may be labelled as Dtarx(t1,t2), where Dtarx(t1,t2)=Σₜ₌ₜ₁^{t2} TArx(t), and where TArx(t) is the relative Timing Advance step received at time t and converted to an equivalent time unit (e.g. seconds unit).

At 9011, the gNB 902 determines a sum of the relative timing adjustment steps transmitted to the UE 801 between the times the first and second round trip time values were calculated. This sum may be labelled as Dtatx(t1,t2), where Dtatx(t1,t2)=Σₜ₌ₜ₁^{t2} TAtx(t), and where TArx(t) is the relative Timing Advance step received at time t and converted to an equivalent time unit (e.g. seconds unit).

At 9012, the UE 901 signals an indication of the results of the determination of 9010 to the gNB 902. To do this, the UE 801 may signal the actual value determined in 9010. In other words, the UE signals Drxtx(t1,t2).

The signalling may be provided in a measurement report. The measurement report may be filtered, for example, conditioned on certain offset threshold value of based on timer since the last measurement report was provided. The measurement report may also be configured to be signalled between non-consecutive receive-transmit events for longer-term monitoring.

Steps 9013 and 9014 relate to the gNB determining an accuracy of the TA relative to the round trip time measurements. This accuracy refers to a consistency/stability of the TA mechanisms.

At 9013, the gNB 902 determines a difference between the values determined in 9009 and 9010. The gNB may additionally or alternatively use proprietary Timing Advance tracking mechanisms to determine an accuracy for the Timing Advance accuracy evaluation.

At 9014, the gNB 902 determines whether the Timing Advance mechanism is inaccurate (e.g. whether the difference between the values determined in 9009 and 9010 is above an accuracy threshold value). When the Timing Advance mechanism is determined to be inaccurate, the gNB 902 may initiate enhancement procedures for improving the accuracy of the Timing Advance procedures. When the Timing Advance mechanism is determined to be accurate, the gNB 902 does not initiate enhancement procedures for improving the accuracy of the Timing Advance procedures.

There are a number of ways in which the Timing Advance procedure may be made more accurate. For example, the accuracy may be increased by increasing the rate at which updates are performed, improving a time of arrival estimation algorithm, decreasing the time between receive-transmit events, and/or disabling of the UE use of Timing Advance for interim adjustments between receive-transmit events.

Steps 9015 to 9016 relate to the gNB 902 determining a reliability of the Timing Advance procedure applied by the gNB 902 relative to the UE 901.

At 9015, the gNB 902 calculates a difference between the values determined at 8010 and 9011. The gNB may additionally or alternatively use proprietary Timing Advance tracking mechanisms to estimate at least one reasons for the different in Timing Advance offsets. For example, there may be differences when different or unreliable mechanisms are employed, such as unreliable physical downlink control channel, an unreliable physical downlink shared channel, and/or differences in Timing Advance mechanisms.

At 9016, the gNB 902 determines whether the Timing Advance mechanism is unreliable (e.g. if the value calculated in 9015 is above a reliability threshold value). When the Timing Advance mechanism is determined to be unreliable, this implies that the UE 901 is not receiving Timing Advance events properly. Therefore, the reliability of Timing Advance transmissions may be improved when the gNB determines that the Timing Advance mechanism is unreliable. The gNB may make no change to the reliability of Timing Advance transmissions when it is determined that the Timing Advance mechanism is reliable.

At 9017, assuming that the Timing Advance mechanism is determined to be accurate and reliable, the gNB 902 reduces the occurrence rate of round trip time measurements such as 9002-9005 so that they occur less frequently. The Timing Advance mechanism may be determined to be both accurate and reliable following a repetition of steps 9001 to 9016 until the Timing Advance is determined to be both accurate and reliable. The use of the Timing Advance mechanisms may be dropped if the Timing Advance mechanism is still determined to be inaccurate and/or unreliable after a predetermined number of steps 9001 to 9016.

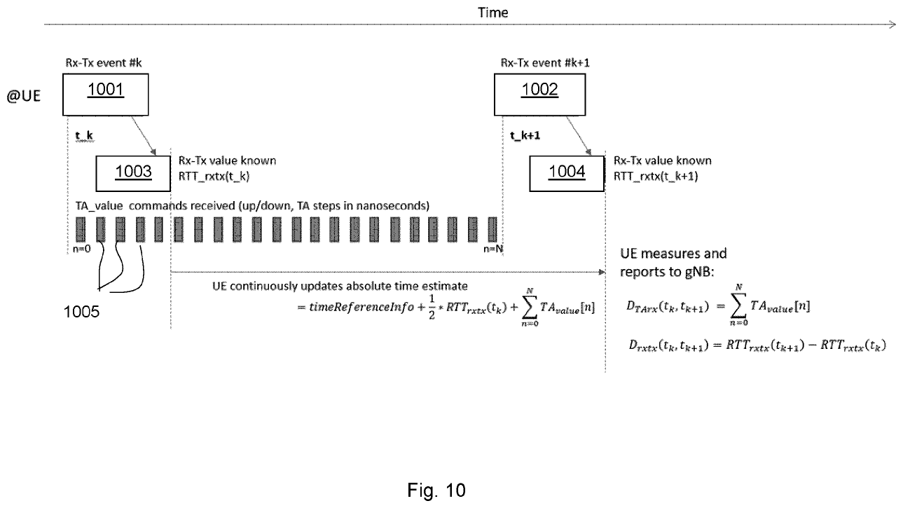

FIG. 10 illustrates aspects of the mechanism described in FIG. 8 from the UE-side.

FIG. 10 shows a first receive-transmit event 1001 at time tk, and a second receive-transmit event at time tk+1, where times tk and tk+1 correspond to time values of a local timer of the UE (with the gNB having an equivalent timer generating the same values). The local timer is tied relative to these defined receive-transmit events, such as by tying the local timer to a first signal in the sequence of signals, to a system frame number, etc.

A first round trip time value 1003 (RTT_rxtx(tk)) is determined from the first receive-transmit event 1001, and a second round trip time value 1004 (RTT_rxtx(tk+1)) is determined from the second receive-transmit event. For each of the first and second receive-transmit events, a consistent “time of event” is defined among the UE and the gNB. This time of event may be defined in a number of ways. For example, the time of event may be the time of the first transmitted/received signal, or the nearest System frame number boundary etc. A time of event may be usefully defined for providing a receive-transmit measuring value that is assumed to be representative for high accuracy, such as defining a time within the event itself. It is understood that these are merely examples, and there are many ways to define the time while ensuring that it time is consistently defined.

FIG. 10 also shows Timing Advance value commands 1005 that have been received by the UE. These Timing Advance commands indicate whether the UE should increase or decrease the timing. The Timing Advance steps may be provided in, for example, nanoseconds.

When RTT_rxtx(tk) is available, the UE compensates its understanding of time by using the provided absolute time (timeReferenceInfo), the RTT_rxtx(tk) estimate, as well as the cumulative Timing Advance changes received by the UE since tk. In other words, the UE compensates its clock by calculating, for “n” received Timing Advance commands:

$$timeReferenceInfo + \frac{1}{2} * R T {T}_{rxtx} ( {t}_{k} ) + {\sum }_{n = 0}^{N} T {A}_{value} [ n ]$$

When the second receive-transmit event occurs, the UE measures and reports two metrics.

One metric is the difference in receive-transmit values for the gNB to know the changes that the UE experiences over time and over the receive-transmit measuring interval. In other words, the UE determines and reports:

$${D}_{rxtx} ( {t}_{k} , {t}_{k + 1} ) = {RTT}_{rxtx} ( {t}_{k + 1} ) - {RTT}_{rxtx} ( {t}_{k} )$$

The other metric is the cumulative sum of the received Timing Advance commands (and their respective time adjustments) for the gNB to assess whether the Timing Advance accurately can be used to predict evolution of the clock between successive receive-transmit measuring events. In other words, the UE determines and reports, for “n” received Timing Advance commands:

$${D}_{TArx} ( {t}_{k} , {t}_{k + 1} ) = {\sum }_{n = 0}^{N} {TA}_{value} [ n ]$$

As discussed above in relation to FIG. 8, the difference between these two metrics may be sent as an alternative to sending both of these metrics in order to compress the signaling (e.x. a “0” value would indicate that Timing Advance commands perfectly track the RTT changes between receive-transmit measuring events). However, it may be beneficial to provide separate values for both metrics so that the gNB may perform more advanced post-processing and analysis than when only the difference is provided.

The above-described techniques allow for fewer frequent receive-transmit propagation delay estimation procedures are needed while maintaining the desired propagation delay estimation accuracy by reusing the already available Timing Advance framework.

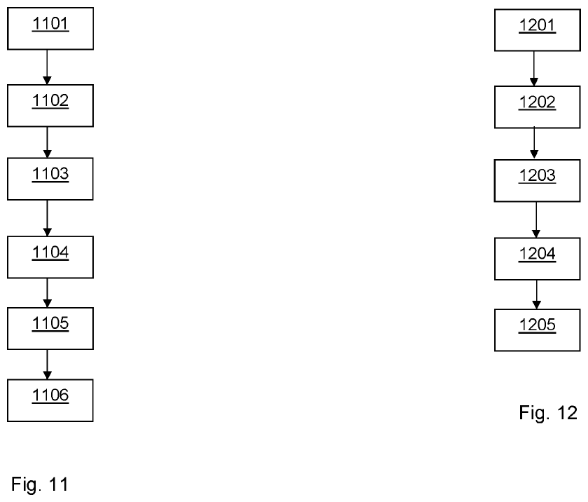

FIGS. 11 and 12 are flow charts illustrating potential operations that may be performed by apparatus described herein, such as those discussed in the above-mentioned examples.

FIG. 11 relates to operations that may be performed by an apparatus for an access point to a network. For example, where the technology is 3GPP, the access point may be a gNB. The access point may be part of a radio access network for facilitating a connection between a user equipment (which includes those equipment not operated by users) and a core network infrastructure.

At 1101, the apparatus signals, to a user equipment, a first configuration for the user equipment to perform at least one measurement for determining a propagation delay for signalling between the user equipment and the access point at a first time and at a third time using a first propagation delay mechanism.

At 1102, the apparatus signals, to the user equipment, a second configuration indicating at least one measurement event for determining a propagation delay for signalling between the user equipment and the access point at a second time using a second propagation delay mechanism, wherein the second time is configured relative to the first time and occurs between the first and third times. The second propagation delay mechanism may provide less accurate values for a propagation delay of communications between the apparatus and the user equipment than the first propagation delay mechanism. For example, the second mechanism may be for determining a propagation delay using a Timing Advance-based mechanism, while the first mechanism may be for determining a propagation delay using a Round Trip Time-based mechanism. The first propagation delay mechanism may comprise more signalling overhead for calculating a propagation delay between the access point and the user equipment than the second propagation delay mechanism.

At 1103, the apparatus receives, from the user equipment, an indication of at least one measurement associated with the first and second configurations. The indication may relate to only the first configuration. The indication may relate to only the second configuration. The indication may relate to both the first and second configurations. The indication may relate to a configuration in that it comprises at least one value derived using that configuration.

At 1104, the apparatus determines at least one of an accuracy and a reliability of the second propagation delay mechanism using the received at least one indication of at least one measurement.

At 1105, the apparatus determines whether to modify the first and/or second configuration in dependence on the determined accuracy and/or reliability.

At 1106, when it is determined to modify the first and/or second configuration, the apparatus signals the modified first and/or second configuration to the user equipment.

The modified second configuration may indicate that measurements according to the second configuration should cease.

The modified first configuration may indicate that a time between making measurements associated with the first propagation delay mechanism should increase.

The apparatus may determine a first value for a propagation delay for signalling using the first propagation delay mechanism at the first time and at least one measurement associated with the first configuration received from the user equipment. In other words, the received indication of 1103 may comprise at least one value derived using the first configuration that is usable for determining a first propagation delay along with at least one measurement performed by the apparatus.

The receiving may comprise receiving a first value for a propagation delay associated with the first configuration at the first time. In other words, the received indication of 1103 may comprise at least one value of a first propagation delay.

The second configuration may indicate a plurality of times between the first time and the third time for said measurement events. These plurality of times may be times at which a measurement for use with the second propagation delay mechanism is to be performed by the user equipment.

The apparatus may determine a second value for a propagation delay using the first propagation delay mechanisms at the third time and at least one measurement associated with the first configuration received from the user equipment.

The receiving of 1103 may comprise receiving a second value for a propagation delay associated with the first configuration at the third time.

The determining an accuracy of the second propagation delay may comprise: determining a first difference between the first value and the second value; determining a first sum of propagation delay values associated with the second configuration at the plurality of times; and determining an accuracy of the second propagation delay mechanism by comparing a difference between the first difference and said sum to a first threshold.

The determining an accuracy of the second propagation delay may comprise: determining a second sum of propagation delay values associated with the second configuration at the plurality of times using measurements performed by the access point; receiving a third sum of propagation delay values associated with the second configuration at the plurality of times from the user equipment; and determining a reliability of the second delay mechanism by comparing a difference between the second sum and the third sum to a second threshold.

The indication of at least one measurement may comprise a difference between a first difference between the first value and the second value and a first sum of propagation delay values associated with the second configuration at the plurality of times.

FIG. 12 is a flow chart illustration potential operations that may be performed by an apparatus for a user equipment. The user equipment may be, for example, the user equipment described above in relation to FIG. 11. As mentioned above, the user equipment need not be operated by a user.

At 1201, the apparatus receives, from an access point, signalling of a first configuration for the user equipment to perform at least one measurement for determining a propagation delay for signalling between the user equipment and the access point at a first time and a third time using a first propagation delay mechanism;

At 1202, the apparatus receives, from the access point, signalling of a second configuration indicating at least one measurement event for determining a propagation delay for signalling between the user equipment and the access point at a second time using a second propagation delay mechanism, wherein the second time is configured relative to the first time and occurs between the first and third times. The second propagation delay mechanism may provide less accurate values for a propagation delay of communications between the apparatus and the user equipment than the first propagation delay mechanism. For example, the second mechanism may be for determining a propagation delay using a Timing Advance-based mechanism, while the first mechanism may be for determining a propagation delay using a Round Trip Time-based mechanism. The first propagation delay mechanism may comprise more signalling overhead for calculating a propagation delay between the access point and the user equipment than the second propagation delay mechanism.

At 1203, the user equipment performs measurements in accordance with the first and second configurations.

At 1204, the user equipment signals an indication of at least one measurement associated with at least one of the first and second configurations to the access point.

At 1205, the user equipment receives at least one modified first configuration and/or modified second configuration. The user equipment may perform future measurements in accordance with the received modified first and/or second configuration.

The modified second configuration may indicate that measurements according to the second configuration should cease.

The modified first configuration may indicate that a time between making measurements associated with the first propagation delay mechanism should increase.

The user equipment may determine a first value for a propagation delay for signalling using the first propagation delay mechanism at the first time; and signal the first value to the access point.

The second configuration may indicate a plurality of times between the first time and the third time for said measurement events. These plurality of times may be times at which a measurement for use with the second propagation delay mechanism is to be performed by the user equipment.

As described above, the NF profile hosted in the NRF comprises information indicating whether an NF is located in the RAN (e.g. inside an IAB-node). Such information may then be used for new services as discussed in the framework for 3GPP Release 18, e.g. for providing local services in an IAB network. Such local services drastically remove the load on the radio links towards the Donor-gNB as the local traffic is handled/offloaded locally in the IAB-Node hosting the local UPF.

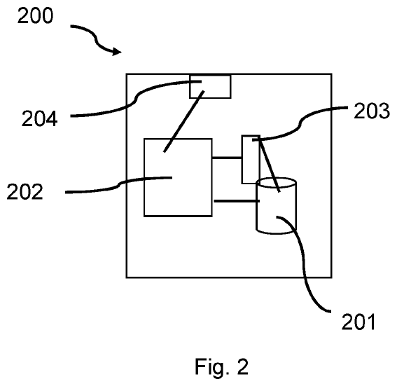

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR etc. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example the control apparatus 200 or processor 201 can be configured to execute an appropriate software code to provide the control functions.

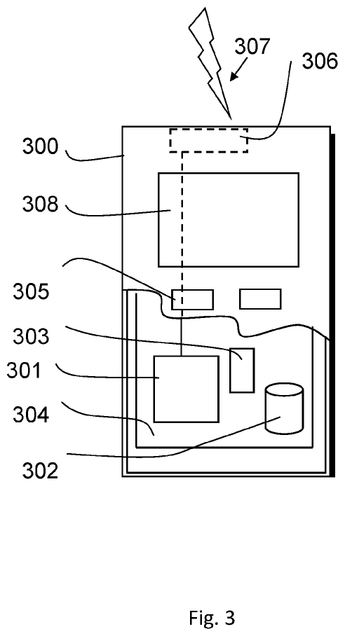

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 704. The user may control the operation of the wireless device by means of a suitable user interface such as key pad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

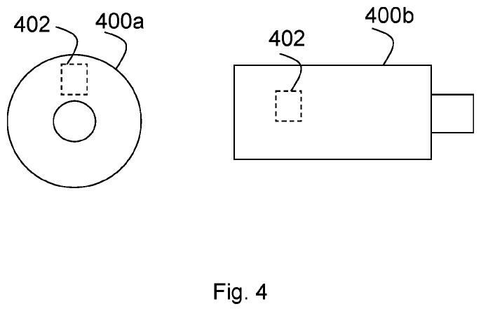

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 11 and/or FIG. 12.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 11 and/or FIG. 12, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

In the above, different examples are described using, as an example of an access architecture to which the presently described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

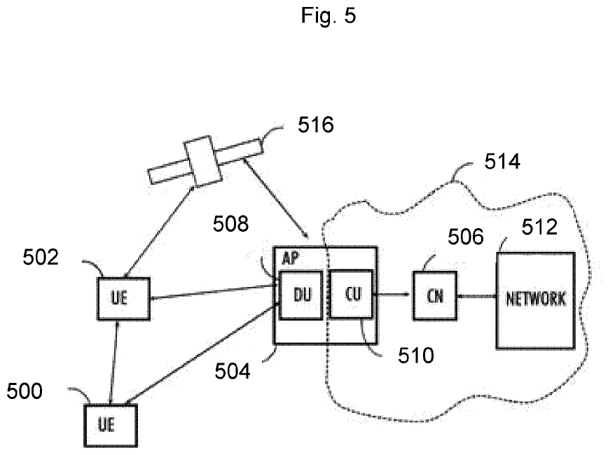

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g)NodeB serving devices in a cell. In one example, the node 504 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 506 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHz-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 5 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 5). A HNB Gateway (HNB-GW), which is typically installed within an operator's network may aggregate traffic from a large number of HNBs back to a core network.

1-21. (canceled)

22. An apparatus, comprising:
at least one processor; and
at least one memory storing instructions that, when executed by the at least one processor, cause the apparatus at least to:
signal, to a user equipment, a first configuration for the user equipment to perform at least one measurement for determining a propagation delay for signalling between the user equipment and the access point at a first time and a third time using a first propagation delay mechanism;
signal, to the user equipment, a second configuration indicating at least one measurement event for determining a propagation delay for signalling between the user equipment and the access point at a second time using a second propagation delay mechanism, wherein the second time is configured relative to the first time and occurs between the first and third times;
receive, from the user equipment, an indication of at least one measurement associated with the first and second configurations;
determine at least one of an accuracy and a reliability of the second propagation delay mechanism using the received at least one indication of at least one measurement;
determine whether to modify the first and/or second configuration in dependence on the determined accuracy and/or reliability; and
when it is determined to modify the first and/or second configuration, signal the modified first and/or second configuration to the user equipment.

23. The apparatus as claimed in claim 22, wherein the instructions, when executed by the at least one processor, cause the apparatus at least to determine a first value for a propagation delay for signalling using the first propagation delay mechanism at the first time and at least one measurement associated with the first configuration received from the user equipment.

24. The apparatus as claimed in claim 22, wherein the receiving comprises receiving a first value for a propagation delay associated with the first configuration at the first time.

25. The apparatus as claimed in claim 23,
wherein the second configuration indicates a plurality of times between the first time and the third time for said measurement events.

26. The apparatus as claimed in claim 25, wherein the instructions, when executed by the at least one processor, cause the apparatus at least to determine a second value for a propagation delay using the first propagation delay mechanisms at the third time and at least one measurement associated with the first configuration received from the user equipment.

27. The apparatus as claimed in claim 25, wherein the receiving comprises receiving a second value for a propagation delay associated with the first configuration at the third time.

28. The apparatus as claimed in claim 26, wherein the determining an accuracy of the second propagation delay comprises:
determining a first difference between the first value and the second value;
determining a first sum of propagation delay values associated with the second configuration at the plurality of times; and
determining an accuracy of the second propagation delay mechanism by comparing a difference between the first difference and said sum to a first threshold.

29. The apparatus as claimed in claim 25, wherein the determining an accuracy of the second propagation delay comprises:
determining a second sum of propagation delay values associated with the second configuration at the plurality of times using measurements performed by the access point;
receiving a third sum of propagation delay values associated with the second configuration at the plurality of times from the user equipment; and
determining a reliability of the second delay mechanism by comparing a difference between the second sum and the third sum to a second threshold.

30. An apparatus as claimed in claim 26, wherein the indication of at least one measurement comprises a difference between a first difference between the first value and the second value and a first sum of propagation delay values associated with the second configuration at the plurality of times.

31. An apparatus, comprising:
at least one processor; and
at least one memory storing instructions that, when executed by the at least one processor, cause the apparatus at least to:
receive, from an access point, signalling of a first configuration for the user equipment to perform at least one measurement for determining a propagation delay for signalling between the user equipment and the access point at a first time and a third time using a first propagation delay mechanism;
receive, from the access point, signalling of a second configuration indicating at least one measurement event for determining a propagation delay for signalling between the user equipment and the access point at a second time using a second propagation delay mechanism, wherein the second time is configured relative to the first time and occurs between the first and third times;
perform measurements in accordance with the first and second configurations;
signal an indication of at least one measurement associated with at least one of the first and second configurations to the access point; and
receive at least one modified first configuration and/or modified second configuration.

32. The apparatus as claimed in claim 31, wherein the instructions, when executed by the at least one processor, cause the apparatus at least to:
determine a first value for a propagation delay for signalling using the first propagation delay mechanism at the first time; and
signal the first value to the access point.

33. The apparatus as claimed in claim 31,
wherein the second configuration indicates a plurality of times between the first time and the third time for said measurement events.

34. The apparatus as claimed in claim 31, wherein the modified second configuration indicates that measurements according to the second configuration should cease.

35. The apparatus as claimed in claim 31, wherein the modified first configuration indicates that a time between making measurements associated with the first propagation delay mechanism should increase.

36. The apparatus as claimed in claim 31, wherein the first propagation delay mechanism is a round trip time mechanism and the second propagation delay mechanism is a timing advance mechanism.

37. The apparatus as claimed in claim 31, wherein the first propagation delay mechanism provides a more accurate value for a propagation delay between the access point and the user equipment than the second propagation delay mechanism.

38. The apparatus as claimed in claim 31, wherein the first propagation delay mechanism comprises more signalling overhead for calculating a propagation delay between the access point and the user equipment than the second propagation delay mechanism.

39. A method, comprising:
receiving, from an access point, signalling of a first configuration for the user equipment to perform at least one measurement for determining a propagation delay for signalling between the user equipment and the access point at a first time and a third time using a first propagation delay mechanism;
receiving, from the access point, signalling of a second configuration indicating at least one measurement event for determining a propagation delay for signalling between the user equipment and the access point at a second time using a second propagation delay mechanism, wherein the second time is configured relative to the first time and occurs between the first and third times;
performing measurements in accordance with the first and second configurations;
signalling an indication of at least one measurement associated with at least one of the first and second configurations to the access point; and
receiving at least one modified first configuration and/or modified second configuration.

40. The method as claimed in claim 39, further comprising:
determining a first value for a propagation delay for signalling using the first propagation delay mechanism at the first time; and
signalling the first value to the access point.

41. The method as claimed in claim 39,
wherein the second configuration indicates a plurality of times between the first time and the third time for said measurement events.
